(19) United States
(12) Patent Application Publication
(10) Pub. No.: US 2016/0329928 A1
(43) Pub. Date: Nov. 10, 2016

(54) SYSTEM AND METHOD FOR EFFICIENT DATA COMPRESSION IN A COMMUNICATION SYSTEM

(71) Applicant: ELSTER SOLUTIONS, LLC, Raleigh, NC (US)

(72) Inventor: Edward J. Beroset, Chapel Hill, NC (US)

(21) Appl. No.: 14/706,651

(22) Filed: May 7, 2015

(51) Int. Cl. H04B 1/66; H04L 29/06; H04L 12/14

(52) U.S. Cl. CPC H04B 1/66; H04L 12/1425; H04L 69/04

(57) ABSTRACT

A method of compressing a message to transmit from one device to another device on a communications network comprises receiving the message to be compressed, the message including a plurality of bytes having respective values. Next, all bytes having a value of 0x00 in the message are encoded with a first code. Then, all other bytes in the message are encoded with a second code followed by the original value of the byte. The encoded message is then transmitted via the network.

### FIELD OF THE INVENTION

The present disclosure relates to electricity metering, and more particularly, to a system and method for efficiently compressing data transmitted within an electricity metering system.

### BACKGROUND

In Advanced Metering Infrastructure (AMI) systems, transmission and reception of data is often performed over TCP/IP between a head-end system and a meter device. The meter device is used for measuring consumption of a commodity at a residential or commercial location, and generally has limited memory and computational ability. In a typical AMI system, control messages transmitted from a head-end system to a meter device tend to be short. However, messages containing consumption date transmitted from the meter device to the head-end system tend to be much larger. Backhaul of data from AMI systems is often accomplished via cellular communications in which the price the utility operator pays is directly proportional to the number of data bytes transferred.

### SUMMARY

Because meter devices typically have limited memory and computational capability, and because the cost of operating the system can be affected by the size of data transfers, it is desirable to both minimize the amount of data traffic between the meter device and the head-end, and to minimize the amount of time that these resources are occupied to effect this transfer. Disclosed herein are methods and systems that address both of these goals.

According to one aspect, a method of compressing a message to transmit from one device to another device on a communications network comprises receiving the message to be compressed, the message including a plurality of bytes having respective values. Next, all bytes having a value of 0x00 in the message are encoded with a first code. Then, all other bytes in the message are encoded with a second code followed by the original value of the byte. The encoded message is then transmitted via the network. In one embodiment, the first code comprises a single bit having a value of ‘1,’ and the second code comprises a single bit haying a value of ‘0’ which is prepended to the original value of the byte.

According to another aspect, a method of decompressing an encoded message transmitted from one device to another device on a communications network comprises receiving the encoded message, decoding each first code encountered in the message as a byte having a value of 0x00, and decoding each second code encountered in the message as a byte having a value equal to the eight bits that follow the second code in the encoded message. Again, in one embodiment, the first code comprises a single bit having a value of ‘1,’ and the second code comprises a single bit having a value of ‘0.’

### BRIEF DESCRIPTION OF THE DRAWINGS

The foregoing Summary, as well as the following detailed description of illustrative embodiments, will be better understood when read in conjunction with the appended drawings. In the drawings:

FIG. 1 illustrates one example metering system in which the methods and systems disclosed herein may be embodied;

FIG. 2A illustrates a schematic of a gatekeeper device/meter, according to an aspect of the disclosure.

FIG. 2B illustrates a schematic of a meter device, according to an aspect of the disclosure.

FIG. 3 illustrates as format for an EPSEM message.

FIG. 4 is a flow diagram illustrating one embodiment of a method of encoding a message, according to an aspect of the disclosure

FIG. 5 is a flow diagram illustrating one embodiment of a method of decoding a message, according to an aspect of the disclosure

### DETAILED DESCRIPTION

Disclosed herein are methods and systems for data encoding/compression in an Advanced Metering infrastructure (AMI) system or the like.

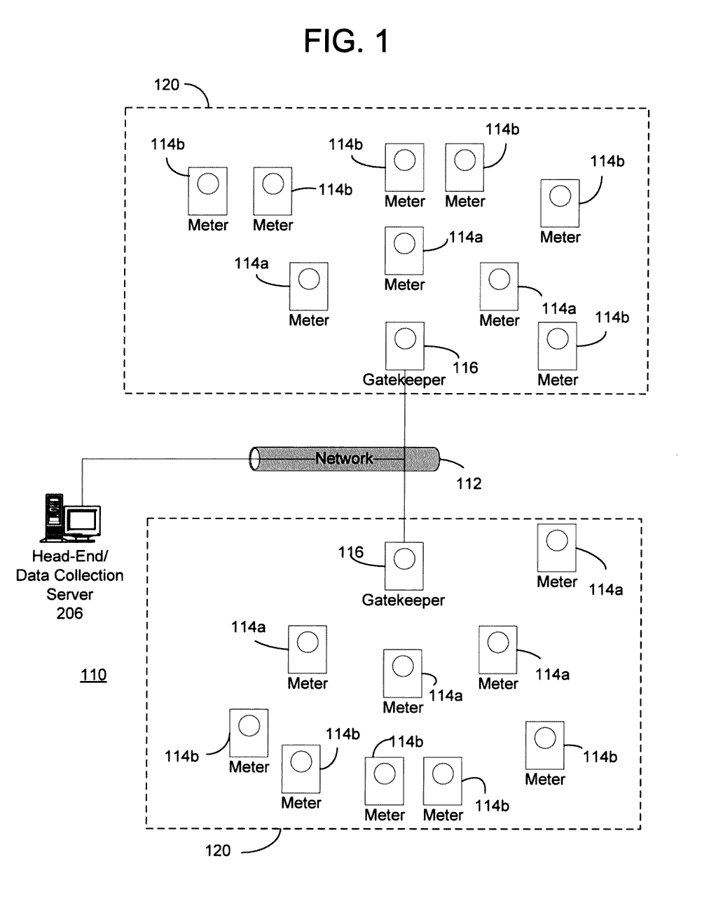

FIG. 1 illustrates one example of a metering system 110 in which the data compression methods and systems disclosed herein may be employed. System 110 comprises a plurality of meters 114, which are operable to sense and record consumption or usage of a service or commodity such as, for example, electricity, water, or gas. Meters 114 may be located at customer premises such as, for example, a home or place of business. Meters 114 comprise circuitry for measuring the consumption of the service or commodity being consumed at their respective locations and for generating data reflecting the consumption, as well as other data related thereto. Meters 114 may also comprise circuitry for wirelessly transmitting data generated by the meter to a remote location. Meters 114 may further comprise circuitry for receiving data, commands or instructions wirelessly as well. Meters that are operable to both receive and transmit data may be referred to as “bi-directional” or “two-way” meters, while meters that are only capable of transmitting data may be referred to as “transmit-only” or “one-way” meters. In bi-directional meters, the circuitry for transmitting and receiving may comprise a transceiver.

System 110 further comprises gatekeepers 116. In one embodiment, gatekeepers 116 are also meters operable to detect and record usage of a service or commodity such as, for example, electricity, water, or gas. In addition, gatekeepers 116 are operable to send data to and receive data from meters 114. Thus, like the meters 114, the gatekeepers 116 may comprise both circuitry for measuring the consumption of a service or commodity and for generating data reflecting the consumption and circuitry for transmitting and receiving data. In one embodiment, gatekeeper 116 and meters 114 communicate with and amongst one another using any one of several wireless techniques such as, for example, frequency hopping spread spectrum (FHSS) and direct sequence spread spectrum (DSSS).

A gatekeeper 116 and the meters 114 with which it communicates may define a subnet/LAN 120 of system 110. As used herein, meters 114 and gatekeepers 116 may be referred to as “metering devices” or “meter devices” in the subnet 120. In each subnet/LAN 120, each meter transmits data related to consumption of the commodity being metered at the meter's location. The gatekeeper 116 receives the data transmitted by each meter 11$, effectively “collecting” it, and then periodically transmits the data from all of the meters in the subnet/LAN 120 to a data collection server or head-end system 206. The data collection server 206 stores the data for analysis and preparation of bills, for example. The data collection server 206 may be a specially programmed general purpose computing system and may communicate with gatekeepers 116 via a network 112. The network 112 may comprise any form of network, including a wireless network or a fixed-wire network, such as a local area network (LAN), a wide area network, the Internet, an intranet, a telephone network, such as the public switched telephone network (PSTN), a Frequency Hopping Spread Spectrum (FHSS) radio network, an ISM mesh network, a Wi-Fi (802.11) network, a Wi-Max (802.16) network, a land line (POTS) network, a cellular network, or any combination of the above.

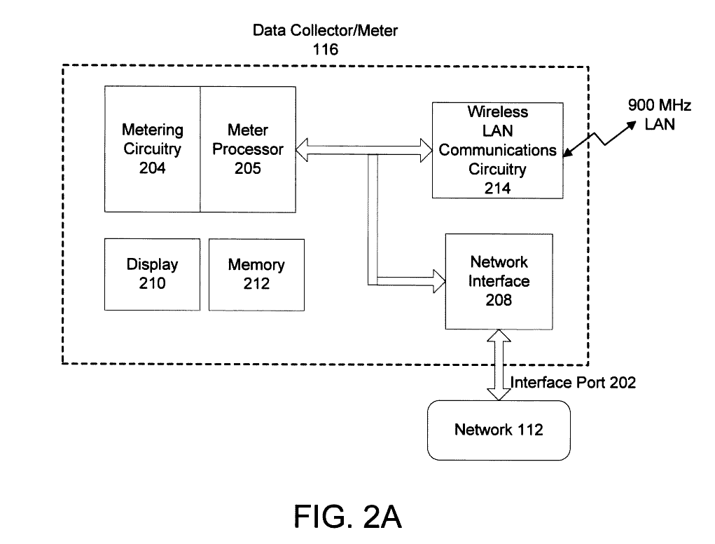

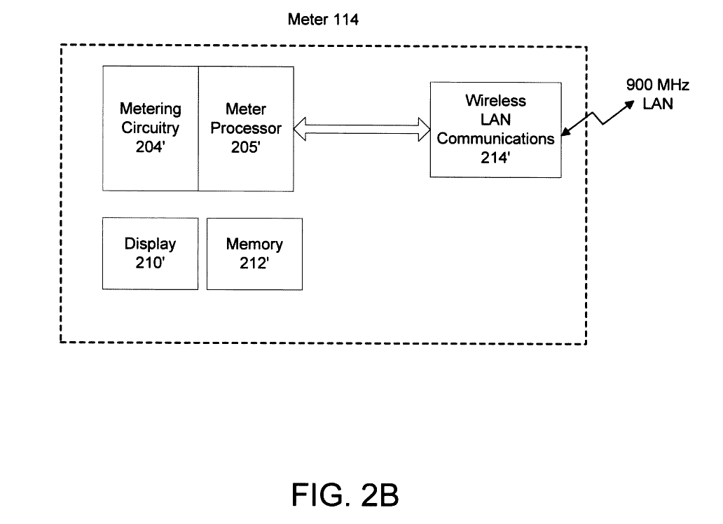

FIG. 2A is a block diagram illustrating further details of one embodiment of a gatekeeper 116. Although certain components are designated and discussed with reference to FIG. 2A, it should be appreciated that the invention is not limited to such components. In fact, various other components typically found in an electronic meter may be a part of gatekeeper 116, but have not been shown in FIG. 2A for the purposes of clarity and brevity. Also, the invention may use other components to accomplish the operation of gatekeeper 116. The components that are shown and the functionality described for gatekeeper 116 are provided as examples, and are not meant to be exclusive of other components or other functionality.

As shown in FIG. 2A, gatekeeper 116 may comprise metering circuitry 204 that performs measurement of consumption of a service or commodity and a processor 205 that controls the overall operation of the metering functions of the gatekeeper 116. The gatekeeper 116 may further comprise a display 210 for displaying information such as measured quantities and meter status and a memory 212 for storing data. The gatekeeper 116 further comprises wireless LAN communications circuitry 214 for communicating wirelessly with the meters 114 in a subnet/LAN and a network interface 208 for communication over the network 112.

In one embodiment, the wireless LAN communications circuitry 214 may be implemented by a 900 MHz two-way radio (i.e., transceiver) installed within the meter, and the network interface 208 may be implemented by a telephone modem or the like also installed within the meter. The network interface 208 routes messages from network 112 (via interface port 202) to either the meter processor 205 or the LAN communications circuitry. The gatekeeper 116 typically has sufficient memory to store data received from meters 114. This data may include, but is not limited to the following: current billing data (e.g., the present values stored and displayed by meters 114), previous billing period data, previous season data, and load profile data.

FIG. 2B is a block diagram of an exemplary embodiment of a meter 114 that may operate in the system 110 of FIG. 1. As shown, the meter 114 comprises metering circuitry 204′ for measuring the amount of a service or commodity that is consumed, a processor 205′ that controls the overall functions of the meter, a display 210′ for displaying meter data and status information, and a memory 212′ for storing data and program instructions. The meter 114 further comprises wireless communications circuitry 214′ for transmitting and receiving data to/from other meters 114 or a gatekeeper 116.

The gatekeeper 116 is responsible for managing, processing and routing data communicated between the gatekeeper and network 112 and between the gatekeeper and meters 114. Gatekeeper 116 may continually or intermittently receive current data from meters 114 and store the dam in memory 212 or a database (not shown) in gatekeeper 116. Such current data may include but is not limited to the total kWh usage, the Time-Of-Use (TOU) kWh usage, peak kW demand, and other energy consumption measurements and status information. Gatekeeper 116 also may receive and store previous billing and previous season data from meters 114 and store the data in memory 212 or the database in gatekeeper 116. The database may be implemented as one or more tables of data within the gatekeeper 116.

In an embodiment, the metering system 110 may be an Advance Metering Infrastructure (AMI) system which uses the ANSI C12.22 protocol for communications among meter devices 114/116 and the head-end system 206. Other protocols, however, could be employed.

In the example system 110 of FIG. 1, transmission of data from a meter 114 to the data collection server/head-end 206 may be initiated by a request sent to the meter 114. The request may be in the form of a C12.22 frame which consists of a header followed by data. The data portion may consist of one or more Extended Protocol Specification for Electric Metering (EPSEM) messages. The C12.22 standard defines thirteen EPSEM services, each with a matching request and response. The C12.22 protocol allows for requests and responses to be concatenated into single C12.22 frames.

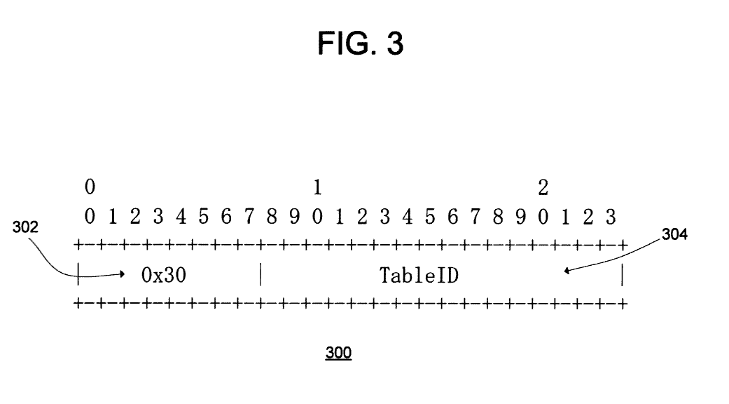

FIG. 3 illustrates a format for an EPSEM read request message 300 for table data. The first portion 302 of the request is a representation of a full table read request. The second portion 304 is a 16-bit TableID, which immediately follows the first portion 302 of the read request. An example format of a read request to read a Standard Table 120 (ST-120) may include the following bytes:
0x03 (length)
0x30 (full table read request)
0x00 0x78 (ST-120)

The 0x03 byte is the length of the read request, the 0x30 byte is the read request code for a full table, and the 0x00 and 0x78 bytes indicate that the TableID is 120. Multiple tables may also be requested within a read request by concatenating requests. The format for a request to read a Standard Table 120 (ST-120) and a Standard Table 121 (ST-121) may look like the following:
0x03 (length)
0x30 (full table read request)
0x00 0x78 (ST-120)
0x03 (length)
0x30 (full table read request)
0x00 0x79 (ST-121)

The first four bytes, 0x03, 0x30, 0x00, and 0x78, represent the read request for the Standard Table 120 as described above. The following four bytes, 0x03, 0x30, 0x00, and 0x79, represent the read request for the Standard Table 121, which are concatenated onto the read request for the Standard Table 120. The 0x03 and the 0x30 bytes are for the length of the read request and the read request code for a full table, respectively. The 0x00 and 0x79 bytes indicate the beginning of the Standard Table 121, which begins at 0x00, and that the TableID is 121, respectively.

The format for a EPSEM response message to a read request may be similar to the format of the read request. A response message may include a byte representing either an error code (a non-zero byte) or an “OK” response code (a 0x00 byte) followed by the data requested. The following illustrates an example response to the read request above for the Standard Table (ST-120) and the Standard Table (ST-121) (the ‘0x’ prefix has been omitted but they are all intended to be interpreted as hexadecimal):
17 (length)
00 (OK)
00 13 5a 01 01 00 00 04 00 10 00 00 00 00 04 00 00 00 00 00 00 8c (ST-120)
17 (length)
00 (OK)
00 13 5a 01 00 00 00 01 00 10 00 00 00 00 04 00 00 a4 14 00 01 d7 (ST -121)

The 0x17 and the 0x00 (OK) represent the length of the response and the response code, respectively. The hexadecimal numbers following the response code represent the data for the Standard Table 120 and the Standard Table 121.

According to one aspect disclosed herein, a data encoding/compression mechanism is provided that is specifically tuned to the unique characteristics of data being transmitted. For example, in an AMI system, in which message are transmitted using the EPSEM format, data logged from several AMI systems was analyzed. It was discovered that the requests from the AMI head-ends to the meter devices tend to be short messages but that the responses coming back from the meter devices tend to be much larger and dominated by just a very few numerical values.

Specifically, in this analysis, of the 6488684 bytes within EPSEM messages, 4098547 or 63% of those bytes were zeroes. This gives an entropy of 0.66 bits for the 0x00 byte meaning that, at least for this corpus of messages, the information content of a 0x00 byte is 0.66 bits. This represents the number of bits ideally required to encode this content in a zero-order statistical model. A zero-order model means that no history is stored, so that each byte is considered independently of bytes that came before. The implication is that for a zero order encoding, this is the best data compression possible and so if each 0x00 byte could be encoded using exactly 0.66 bits (theoretically possible using arithmetic coding), those 4098547 bytes could be encoded in 2716571.73 bits (4098547*0.66). If that calculation is done for all of the bytes and summed together, the result is a size of 2424449 bytes which represents, unambiguously, all 6488684 of the original size message. Thus, it was discovered that by specially encoding the 0x00 bytes, an EPSEM message may be desirably compressed, thereby limiting the number of bytes transmitted over the AMI network.

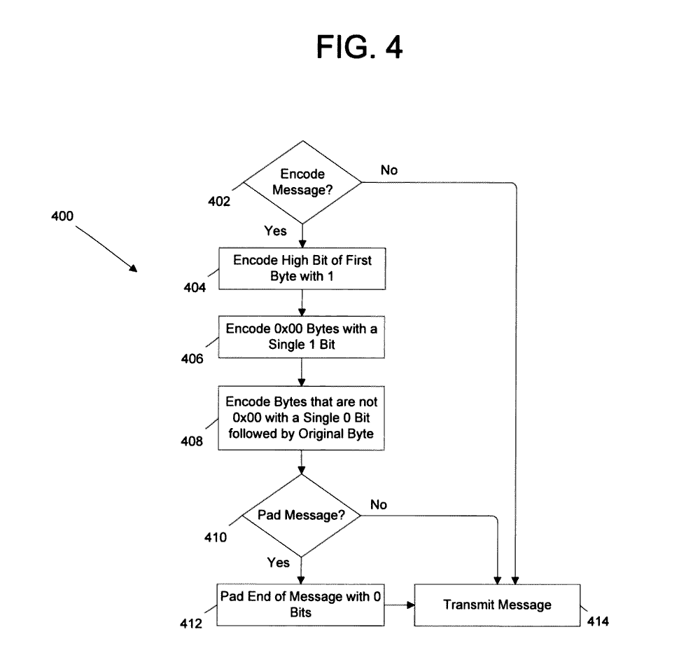

FIG. 4 illustrates an embodiment of a method 400 for encoding a message, such as, for example, an EPSEM message, as disclosed herein. Computer-executable instructions (i.e., program code) for performing the method 400 may be stored in the memory 212 of a gatekeeper 116, the memory 212′ of a meter 114, and/or a memory (not shown) of a head-end system 206, and such instructions may be executed by a processor (e.g., processor 205 of the gatekeeper 116, processor 205′ of the meter 114, and/or a processor (not shown) of the head-end system 206) to perform the method on the respective device/system.

As shown in FIG. 4, in step 402 a determination is made whether to encode a message, such as an EPSEM message, to compress the message. If the message is not to be encoded, then, at step 416, the message may simply be transmitted at step 414. The determination in step 402 may be made, for example, to distinguish between certain types of messages for which desirable compression may or may not be achieved. Few example, in an AMI system, because messages from the head-end to a meter device tend to be relatively short, such messages may not be specially encoded as described herein. Alternatively, some analysis may be performed on the data of a given message to determine whether encoding the message would result in a threshold level of compression.

However, if the message is to be encoded, then, at step 404, the high bit of the first byte of the message is, in the present embodiment, encoded with a ‘1’ value. The C12.22 protocol defines read request codes in the range of 0x20 through 0x7F and response codes in the range of 0x00 through 0x1F. Therefore, by setting the high bit of the first byte to a ‘1’ value, that puts the byte in the range of 0x80 through 0xFF. This can be unambiguously detected by a decoding device as an encoded message because it is outside the defined C12.22 ranges for read and response requests. It should be appreciated that in other embodiments other bits or multiple bits may be encoded to indicate that a message is either encoded or not encoded, and thus, in those embodiments, a different mechanism for identifying an encoded message may be employed in step 404.

At step 406, after the message has been marked to indicate that it is to be compressed, each of the bytes having a value of 0x00 are specially encoded. In the present embodiment, each of the 0x00 bytes is replaced by a single ‘1’ bit, thereby compressing the size of each byte from eight bits to a single bit. It should be appreciated that, in other embodiments, the 0x00 byte may be replaced by more than or less than a single bit. For example, the entropy to encode a byte may be less than 1, thereby allowing the byte to be replaced by less than one bit. Further, the 0x00 byte may be replaced by multiple bits either because the entropy is greater than 1 or for other reasons, such as for example, more complex encoding schemes.

At step 408, each of the non-zero bytes may then be encoded. In this embodiment, a 9-bit encoding scheme is used, whereby a single ‘0’ bit is followed by the original 8-bit byte value. This step increases the total size of the encoded message by adding a single bit to Indicate the byte is not compressed. However, that increase should be outweighed by the compression achieved in step 406. Other embodiments may include adding more than a single bit to each byte or by encoding specific bits within the byte.

After the encoding in steps 406 and 408, there may be extra bits at the end of the encoded message, for example, less than 8 bits. As shown at step 410, if there are no extra bits, then, control passes to step 414, where the encoded message is transmitted. However, if there are extra bits, at step 412, the encoded message may be padded with single bits to define a full byte, for example, by padding the message with ‘0’ bits. The padded message is then transmitted at step 414.

It should be appreciated that, in some embodiments, within a single EPSEM message, some response data may be encoded while other response data may not be encoded. Also, in an embodiment, the encoding may only be used for response messages that begin with 0x00 (OK). In such an embodiment, if the response code is an error code (which begins with a non-zero byte), then the response data is not encoded.

At step 414, the encoded message, or the original message if the message was not encoded, is transmitted, for example, from a metering device 114/116 to a head-end system 206 or vice-versa.

In one embodiment, the data compression process 400 may be unidirectional. For example, in an AMI system, the data compression process 400 may only be performed for response data being sent by a metering device 114/116 to a head-end system 206. In other embodiments, the compression process 400 may also be bi-directional. For example, in an AMI system, the process 400 may be used for both read request messages sent from the head-end system 206 to the metering, devices 114/116 and the responses thereto.

The following example illustrates a message encoded according to an embodiment of the data compression process 400. This illustration uses the response message for the Standard Table 120 and the Standard Table 121 discussed above. The response message is shown as an unstructured series of binary digits because the structure of the data within an EPSEM message does not affect the compression process. The following illustrates the response messages in binary format:
(length byte)
00000000 00000000 00010011 01011010 00000001 00000001 00000000
00000000 00000100 00000000 00010000 00000000 00000000 00000000
00000000 00000100 00000000 00000000 00000000 00000000 00000000
00000000 10001100
(length byte)
00000000 00000000 00010011 01011010 00000001 00000000 00000000
00000000 00000001 00000000 00010000 00000000 00000000 00000000
00000000 00000100 00000000 00000000 10100100 00010100 00000000
00000001 11010111

The response for the Standard Table 120 has 23 bytes and the response for Standard Table 121 has 23 bytes. Encoding the message according to steps 406 and 408, whereby each 0x00 byte is encoded with a single ‘1’ bit and all other bytes are encoded with a ‘0’ bit followed by the original byte, would result in the following, message:
(length byte)
1 1 0 00010011 0 01011010 0 00000001 0 00000001 1
1 0 00000100 1 0 00010000 1 1 1
1 0 00000100 1 1 1 1 1
1 0 10001100
(length byte)
1 1 0 00010011 0 01011010 0 00000001 1 1
1 0 00000001 1 0 00010000 1 1 1
1 0 00000100 1 1 0 10100100 0 00
0 00000001 0 11010111

Regrouping this into 8-bytes yields:
length byte)
11000010 01100101 10100000 00001000 00000111
00000010 01000010 00011110 00000100 11111101
0001100
(length byte)
11000010 01100101 10100000 00001111 00000000
11000010 00011110 00000100 11010100 10000001
01001000 00000101 1010111

The response for the Standard Table 120 results in 87 bits, or 10.875 bytes. The response for the Standard Table 121 results in 103 bits, or 12.875 bytes. Because the transport may only send whole bytes of data, the message may be padded, according to step 412, with ‘0’ bits. This will produce a message with whole bytes as follows:
(length byte)
11000010 01100101 10100000 00001000 00000111
00000010 01000010 00011110 00000100 11111101
00011000
(length byte)
11000010 01100101 10100000 00001111 00000000
11000010 00011110 00000100 11010100 10000001
01001000 00000101 10101110

The padded response for the Standard Table 120 results in 88 bits, or 11 bytes. The padded response for the Standard Table 121 results in 104 bits, or 13 bytes. This message may be converted back into hexadecimal form, including an updated length byte, and read as follows:
0B (length of compressed message)
C2 65 A0 08 07 02 42 IE 04 ED 18
0D (length of compressed message)
C2 65 A0 0F 00 C2 1E 04 D4 81 48 05 AE

This as an example of a compressed version of the message produced according to an embodiment of the compression process 400, that would be transmitted by a metering device 114/116 to a head-end system 206 for decoding and processing. The resulting 11 bytes and 13 bytes for Standard Table 120 and Standard Table 121, respectively, is significantly less than their original sizes of 23 bytes each.

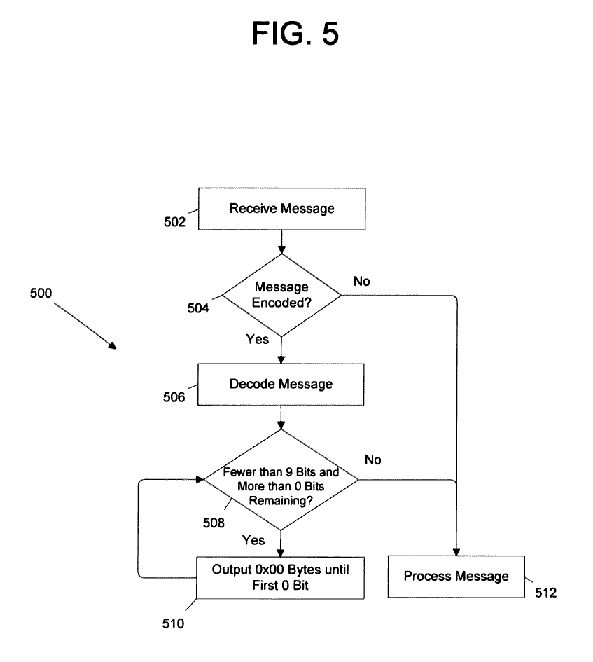

FIG. 5 illustrates an embodiment of a method 500 for decoding a message, such as an EPSM message, as disclosed herein. Computer-executable instructions (i.e., program code) for performing the method 500 may be stored in the memory 212 of a gatekeeper 116, the memory 212′ of a meter 114, and/or a memory not shown) of a head-end system 206, and such instructions may be executed by a processor (e.g., processor 205 of the gatekeeper 116, processor 205′ of the meter 114, and/or a processor (not shown) of the head-end system 206) to perform the method on the respective device/system.

At step 502, the transmitted message is received by, for example, a receiver (not shown). After reception, at step 504, the processor of the receiving device/system determines whether the received message is encoded. As mentioned above, in one embodiment, the high bit of the first byte of a message may be set to ‘1’ to indicate that the message is encoded/compressed. In that embodiment, if the high bit of the first byte is a ‘0,’ then the processor determines that the message is not encoded and processes the message, at step 512, without using any special decoding. However, if the high bit of the first byte is a ‘1,’ then the message has been encoded and must be decoded, at step 506, prior to processing the message. As mentioned above, in other embodiments, other mechanisms for indicating that a message is encoded may be employed, and thus, step 504 may be performed in accordance with those mechanisms.

If the message has been encoded, at step 506, the encoded message is decoded. In an embodiment in which the message has been encoded in accordance with the steps illustrated FIG. 4, each ‘1’ bit that is encountered is replaced by a 0x00 byte. Each ‘0’ bit is replaced by the 8 bits immediately following, thereby removing the prepended ‘0’ bit that was added during the encoding process.

At step 508, at the end of the encoded message, determination of whether there are fewer than 9 bits and greater than 0 bits is made. If the number of bits remaining is not within this range, then the message has been decoded and may be processed at step 512. If the message falls within this range, then each ‘1’ bit encountered is replaced by a 0x00 byte. This continues until a ‘0’ bit is encountered, which indicates the padded portion of the encoded message. The ‘0’ bit may be discarded and the resulting message may be processed at step 512.

The following illustrates an encoded message being decoded according to an embodiment of the decoding process 500. This illustration is to continuation of the encoded response message for the Standard Table 120 and the Standard Table 121 discussed above. The following illustrates an encoded response message:
0B (length of compressed message)
C2 65 A0 08 07 02 42 1E 04 FD 18
0D (length of compressed message)
C2 65 A0 0F 00 C2 IE 04 D4 81 48 05 AE

To more easily illustrate the process, the actual data portions may be rendered in binary.
(length byte)
11000010 01100101 10100000 00001000 00000111
00000010 01000010 0001111 00000100 11111101
00011000
(length byte)
11000010 01100101 10100000 00001111 00000000
11000010 00011110 00000100 11010100 10000001
01001000 00000101 10101110

The Standard Table 120 is encoded with 11 bytes and the Standard Table 121 is encoded with 13 bytes. Each ‘1’ bit represents a 0x00 byte and each ‘0’ bit represents that the following 8 bits are to be substituted. When there are fewer than 9 bits left to decode, this represents the padding.
(length byte)
1 1 0 00010011 0 01011010 0 00000001 0 00000001 1 1
0 00000100 1 0 00010000 1 1 1 1 0 00000100
1 1 1 1 1 1 0 10001100 0 (last bit is padding)
(length byte)
1 1 0 00010011 0 01011010 0 00000001 1 1 1
0 00000001 1 0 00010000 1 1 1 1 0 00000100
   1 1 0 10100100 0 00010100 1 0 00000001 0 11010111 0 (last bit is padding)

Decoding the message according to steps 506, 508, and 510, each ‘1’ bit is replaced by as 0 byte and each ‘0’ bit is replaced by the 8 bits following the ‘0’ bit. If there are fewer than 9 bits and greater than 0 bits remaining, then each ‘1’ bit is replaced with a 0x00 byte until a ‘0’ bit is encountered. The ‘0’ bit indicates that the message has been padded and can be disregarded. The following message results from the decoding process:
(length byte)
00000000 00000000 00010011 01011010 00000001 00000001 00000000
00000000 00000100 00000000 00010000 00000000 00000000 00000000
00000000 00000100 00000000 00000000 00000000 00000000 00000000
00000000 10001100
(length byte)
00000000 00000000 00010011 01011010 00000001 00000000 00000000
00000000 00000001 00000000 00010000 00000000 00000000 00000000
00000000 00000100 00000000 00000000 10100100 00010100 00000000
00000001 11010111

The length of the decoded message for the Standard Table 120 is 23 bytes. The length of the decoded message for the Standard Table 121 is 23 bytes. Convening this message back into hexadecimal results in the following decoded message:
17 (length)
00 (OK)
00 13 5a 01 01 00 00 04 00 10 00 00 00 00 04 00 00 00 00 00 00 8c (ST-120)
17 (length)
00 (OK)
00 13 5a 01 00 00 00 01 00 10 00 00 00 00 04 00 00 a4 14 00 01 d7 (ST-121)

The decoded message results in the same message as the original (prior to encoding) message.

The present disclosure provides an advantageous system and method for compressing messages sent within a communication system, such as an AMI system. The disclosed methods may require little additional code or memory to implement.

As is apparent from the embodiments described herein, all or portions of the systems, methods, and aspects disclosed herein may be embodied in the form of computer executable instructions (i.e., program code) stored on a computer-readable storage medium, which instructions, when executed by a processor, perform and/or implement the systems, methods, and aspects described herein. Computer readable storage media include both volatile and nonvolatile, removable and non-removable media implemented in any method or technology for storage of information. Computer readable storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information, and which can be accessed by a computer. These storage media may be integrated into a processor or may be separate components within a device. As used herein, the term “computer readable storage media” or the like does not include signals.

While the disclosure is described herein using a limited number of embodiments, these specific embodiments are for illustrative purposes and are not intended to limit the scope of the disclosure as otherwise described and claimed herein. Modification and variations from the described embodiments exist. The scope of the invention is defined by the appended claims.

What is claimed is:

1. A method of compressing a message to transmit from one device to another device a communications network, the method comprising:
receiving the message to be compressed, the message including a plurality of bytes having respective values;
encoding all bytes having a value of 0x 00 in the message with a first code;
encoding all other bytes in the message with a second code followed by the original value of the byte; and
transmitting the encoded message via the network.

2. The method of claim 1, wherein the first code comprises a single bit having a value of ‘1’.

3. The method of claim 1, wherein the second code comprises a single bit having a value of ‘0’ that is prepended to the original byte.

4. The method of claim 1, wherein one of the devices comprises a meter device and the other device comprises a utility head-end in an advanced metering infrastructure (AMI) system.

5. The method of claim 4, wherein the steps for encoding the message and transmitting the encoded message are unidirectional.

6. The method of claim 1, further comprising:
when there are fewer than 8 bits at the end of the encoded message, padding the message with ‘0’ bits to a full 8 bits.

7. The method of claim 1, wherein the message comprises an Extended Protocol Specification for Electric Metering (EPSEM) message.

8. A method of decompressing encoded message transmitted from one device to another device on a communications network, the method comprising:
receiving the encoded message;
decoding each first code encountered in the message as a byte having a value of 0x00; and
decoding each second code encountered in the message as a byte having a value equal to the eight bits that follow the second code in the encoded message.

9. The method of claim 8, wherein the first code comprises a single bit having a value of ‘1’.

10. The method of claim 8, wherein the second code comprises a single bit having a value of ‘0’.

11. A device having a processor and a memory, the memory containing computer-executable instructions that, when executed by the processor, cause the device to:
receive a message to be compressed, the message including a plurality of bytes having respective values;
encode all bytes having a value of 0x00 in the message with a first code;
encode all other bytes in the message with a second code followed by the original value of the byte; and
transmit the encoded message via as network.

12. The device of claim 11, wherein the first code comprises a single bit having a value of ‘1’.

13. The device of claim 11, wherein the second code comprises a single bit having a value of ‘0’ that is pre-pended to the original byte.

14. The device of claim 11, wherein the devices comprises one of a meter device or a utility head-end system.

15. The device of claim 11, wherein the computer-executable instructions further cause the device to:
when there are fewer than 8 bits at the end of the encoded message, pad the message with ‘0’ bits to a full 8 bits.

16. A device having a processor and a memory, the memory containing computer-executable instructions that, when executed by the processor, cause the device to:
receive an encoded message;
decode each first code encountered in the message as a byte having a value of 0x00; and
decode each second code encountered in the message as a byte haying a value equal to the eight bits that follow the second code in the encoded message.

17. The device of clam 16, wherein the first comprises a single bit having a value of ‘1’.

18. The method of claim 16, wherein the second code comprises single bit having a value of ‘0’ that is pre-pended to the original byte.
